(19) United States
(12) Patent Application Publication
(10) Pub. No.: US 2015/0006180 A1
(43) Pub. Date: Jan. 1, 2015

(54) SOUND ENHANCEMENT FOR MOVIE THEATERS

(71) Applicant: Lloyd Trammell, Thousand Oaks, CA (US)

(72) Inventor: Lloyd Trammell, Thousand Oaks, CA (US)

(73) Assignee: Max Sound Corporation, La Jolla, CA (US)

(21) Appl. No.: 14/187,196

(22) Filed: Feb. 21, 2014

Related U.S. Application Data
(60) Provisional application No. 61/767,737, filed on Feb. 21, 2013.

(51) Int. Cl. G10L 21/0356; G10L 19/26

(52) U.S. Cl. CPC G10L 21/0356; G10L 19/26
USPC 704/258

(57) ABSTRACT

A process and system for enhancing and customizing movie theatre sound includes receiving an input audio sound and enhancing the voice audio input in two or more harmonic and dynamic ranges by re-synthesizing the audio into a full range PCM wave. The enhancement includes the parallel processing the input audio via a low pass filter with dynamic offset, an envelope controlled bandpass filter, a high pass filter, adding an amount of dynamic synthesized sub bass to the audio and combining the four treated audio signals in a summing mixer with the original audio.

### CROSS-REFERENCE TO RELATED PATENT APPLICATIONS

Embodiments of the present invention relate to U.S. Provisional Application Ser. No. 61/767,737, filed Feb. 21, 2013, entitled “MOVIE THEATER SOUND SYSTEM”, the contents of which are incorporated by reference herein and which is a basis for a claim of priority.

### BACKGROUND OF THE INVENTION

Movie theater sound systems are conventionally 5.1, 7.1, or more in their configuration. While these systems sound good, they are usually very loud in order to fill a theater with audio. There is a “Sweet Spot” where the convergence of the system audio is the best sounding, meaning that anything out of the small “Sweet Spot” has a less desirable seat. Meaning that if user sits directly under the Rear Left speaker, then that is the predominant audio source user will hear.

The disadvantage of the conventional sound system for movie theatres is that there only very few “sweet spots” in a theater.

### SUMMARY OF THE PREFERRED EMBODIMENT(S)

By apply the Max Sound Movie Theater Process to this the “Sweet Spot” is enlarged to be almost the entire listening environment. This alleviates having to be very loud and allows everyone in the theater to have a full, clear sound experience.

The Max Sound Process for Movie Theater Sound System is suitable for use in commercial Movie Theatres. In a typical system, shown in FIG. 3, there will be 6 audio channels that will be specific inputs into the system. They are: 1.) Left Out, 2.) Right Out, 3.) Rear Left Out, 4.) Rear Right Out, 5.) Center Out, and 6.) LFE Out. These outputs together represent the audio outputs of a 5.1 surround system. Each of these outputs flow into the corresponding Max Sound Process channel or input.

The Max Sound Process will work in pairs for this application, except for the LFE processor. The following is an example of the process flow as shown in FIG. 4.

Left/Right—signal flow as chart designates

Rear Left/Rear Right—Signal flow as chart designates

Center—This is a mono signal split into two mono signals (dual mono) and follows the signal flow as chart designates. It is summed together as a mono output.

LFE—This is the SUB BASS portion of the process only. No other modules are needed for this.

To expand to other sizes (formats) such as 7.1, one would create more of the appropriate processes in the system. For example a 7.1 system would add two mid/side speakers to the existing system.

This type of system typically would require some type of decoder before it such as DTS, Dolby, SDDS, etc. Those processes would split the audio into single channels for processing and continuing the signal path to the amplifier and speakers in an environment.

The Stereo Max Sound Processor section contains the following parts to form the complete process.

### BRIEF DESCRIPTION OF THE DRAWINGS

FIG. 1 is a block diagram of the basic signal flow according to an embodiment of the present invention.

FIG. 2 shows a typical use/implementation of the inventive Max Sound Processor according to an embodiment of the present invention.

FIG. 3 is a flow chart of the application of the present invention according to an exemplary embodiment.

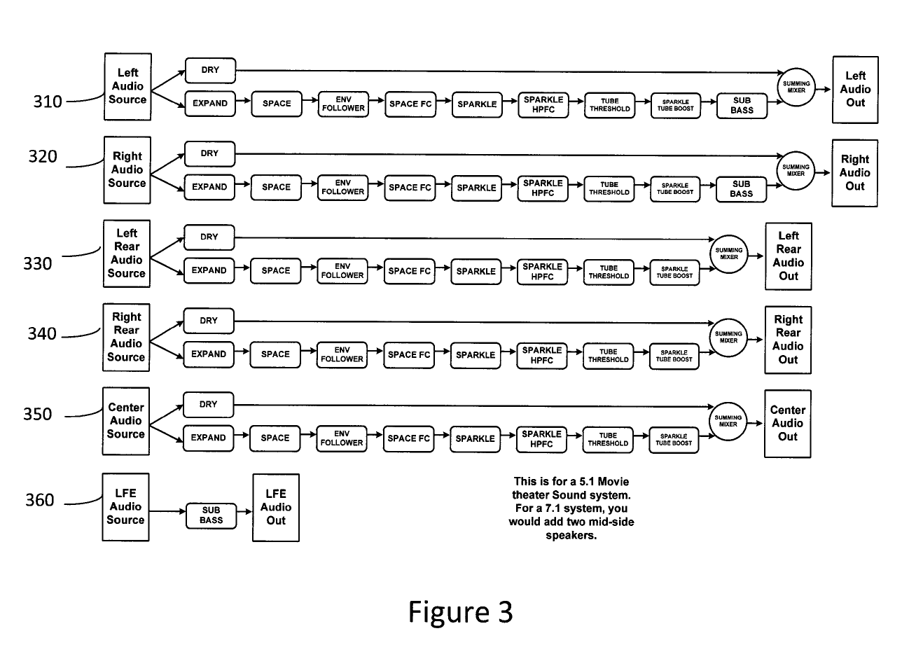

### DETAILED DESCRIPTION OF THE PREFERRED EMBODIMENT(S)

Implementing the inventive process results in an increase in the harmonic and dynamic range of these movie theater speakers. Since the process is dynamic in its control method, it also eliminates many of the phase anomalies that occur in normal unprocessed speakers. This will make them more efficient and much clearer sounding with the same hardware.

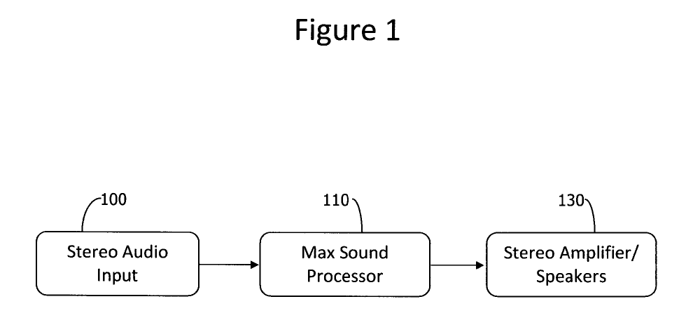

When the audio is input into this device there is typically an input level control that controls the gain or volume of the entire unit. The audio path is, e.g., as shown in FIG. 1 with the audio ending at the speakers for user listening.

Details of the preferred embodiments of the present invention will now be further explained by reference to the drawings.

Referring to FIG. 1, audio input 100 is fed to the inventive Max Sound Processor 110 for processing. The processing results in an increase in the harmonic and dynamic range of these speakers. Since the process is dynamic in its control method, it also eliminates many of the phase anomalies that occur in normal unprocessed speakers. This will make them more efficient and much clearer sounding with the same hardware. Sound processed by the inventive Max Sound Processor 110 is outputted to the speakers 120.

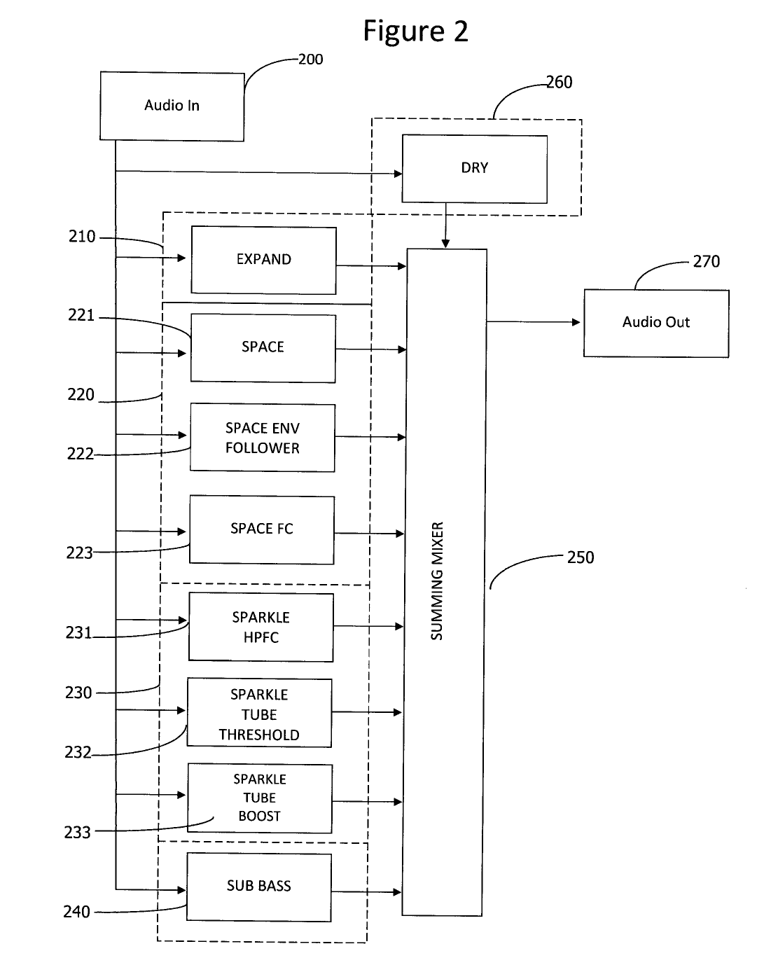

Further details of the inventive Max Sound Processor will now be described with reference to FIG. 2. Stereo Audio input 200 is processed, in parallel, by several module as follows. EXPAND 210 is preferably a 4 pole digital low pass filter with an envelope follower for dynamic offset (fixed envelope follower). This allows the output of the filter to be dynamically controlled so that the output level is equal to whatever the input is to this filter section. For e.g., if the level at the input is −6 dB, then the output will match that. Moreover, whenever there is a change at the input, the same change will occur at the output regardless of either positive or negative amounts. The frequency for this filter is, e.g., 20 to 20 k hertz, which corresponds to a full range. In one embodiment, the purpose of EXPAND 310 is to “warm up” or provide a fuller sound as waveform 100 passes through it. The original audio 200 passes through, and is added to the effected sound for its output. As the input amount varies, so does the phase of this section. This applies to all filters used in this software application. Preferably all filters are of the Butterworth type.

Next, we discuss SPACE 220. SPACE 220 refers to the block of three modules identified by reference numerals 221, 222 and 223. The first module SPACE 221—which follows EXPAND 210 envelope follower, sets the final level of this module. This is the effected signal only, without the original. SPACE ENV FOLLOWER 222 tracks the input amount and forces the output level of this section to match. SPACE FC 223 sets the center frequency of the 4 pole digital high pass filter used in this section. This filter also changes phase as does EXPAND 210.

SPACE blocks 220 are followed by the SPARKLE 230 blocks. Like SPACE 220, there are several components to SPARKLE. SPARKLE HPFC 231 is a 2 pole high pass filter with a preboost which sets the lower frequency limit of this filter. Anything above this setting passes through the filter while anything below is discarded or stopped from passing. SPARKLE TUBE THRESH 232 sets the lower level at which the tube simulator begins working. As the input increases, so does the amount of the tube sound. The tube sound adds harmonics, compression and a slight bit of distortion to the input audio 200. This amount increases slightly as the input level increases. SPARKLE TUBE BOOST 233 sets the final level of the output of this module. This is the effected signal only, without the original.

Next, the SUB BASS 240 module is discussed. This module takes the input signal and uses a low pass filter to set the upper frequency limit to about 100 Hz. An octave divider occurs in the software that changes the input signal to lower by an octave (12 semi tones) and output to the only control in the interface, which is the level or the final amount. This is the effected signal only, without the original.

Outputs from the above modules 210 to 240 are directed into SUMMING MIXER 250 which combines the audio. The levels going into the summing mixer 250 are controlled by the various outputs of the modules listed above. As they all combine with the original signal 200 fed through the DRY 260 module there is interaction in phase, time and frequencies that occur dynamically. These changes all combine to create a very pleasing audio experience for the listener in the form of “enhanced” audio content. For example, a change in a single module can have a great affect on what happens in relation to the other modules final sound or the final harmonic output of the entire software application.

With reference to FIG. 4, Left/Right 410 and 420—show signal flow as chart designates; Rear Left/Rear Right 430 and 440—show signal flow as chart designates; Center 450 is a mono signal split into two mono signals (dual mono) and follows the signal flow as chart designates. It is summed together as a mono output; LFE 460 is the SUB BASS portion of the process only. No other modules are needed for this. To expand to other sizes (formats) such as 7.1, you would just create more of the appropriate processes in the system. For example a 7.1 system would add two mid/side speakers to the existing system. This type of system typically would require some type of decoder before it such as DTS, Dolby, SDDS, etc. Those processes would split the audio into single channels for processing and continuing the signal path to the amplifier and speakers in an environment. The Stereo Max Sound Processor section contains the following parts to form the complete process.

What is claimed is:

1. A process and system for enhancing and customizing a movie theater sound comprising:
Receiving an input audio sound;
Enhancing the voice audio input in two or more harmonic and dynamic ranges by re-synthesizing the audio into a full range PCM wave;
Outputting the enhanced audio sound.

2. The process of claim 1, wherein the enhancement includes the parallel processing the input audio as follows:
A module that is a low pass filter with dynamic offset;
An envelope controlled bandpass filter;
A high pass filter;
Adding an amount of dynamic synthesized sub bass to the audio;
Combining the four treated audio signals in a summing mixer with the original audio.
